(19) United States
(12) Patent Application Publication
(10) Pub. No.: US 2005/0157521 A1
(43) Pub. Date: Jul. 21, 2005

(54) Backlight assembly for liquid crystal display

(76) Inventors: Shih-Hsien Chen, Shengang Township (TW); Kuang-Tao Sung, Fongyuan City (TW)

Correspondence Address: David I. ROCHE;BAKER & McKENZIE, 130 E. Randolph Drive, Chicago, IL, 60601, US

(21) Appl. No.: 10/760,562

(22) Filed: Jan. 20, 2004

(51) Int. Cl. F21V 7/04

(52) U.S. Cl. 362/633

(57) ABSTRACT

A backlight assembly includes a frame configured to mount a liquid crystal panel, a light-guide plate and one or more light-emitting devices. The frame includes a plurality of conductive members embedded in the body of the frame and protruding into contact pads for connecting to the light-emitting device. The conductive members externally connect to a power source to supply electrical current to the light-emitting device.

### FIELD OF THE INVENTION

The present invention generally relates to a backlight device for a liquid crystal display (LCD), and more particularly to a frame structure of such a backlight device.

### DESCRIPTION OF THE RELATED ART

In transmissive and transflective LCD, a backlight is conventionally used to illuminate the liquid crystal panel from behind, i.e. opposite to the viewer side. FIG. 1A is a perspective view of the assembly of a conventional backlight in a LCD system according to the prior art, and FIG. 1B is a cross-sectional view taken along the section 1B in FIG. 1A. The construction of a LCD system conventionally includes a frame 63 in which are assembled in stack a liquid crystal panel 10, prism layers 22, 24, a light-diffusing layer 26, a light-guide plate 61 and a reflective sheet 65, respectively. The liquid crystal panel 10 is usually coupled with a flexible printed circuit 12 configured to drive its operation.

The frame 63 is usually rectangular, corresponding to the general profile of the liquid crystal panel 10. A side of the frame 63 carries the mount of a fluorescent lamp 66 and reflector 67. The fluorescent lamp 66 conventionally is a cold cathode fluorescent lamp. A flexible printed circuit 68 is assembled over the fluorescent lamp 66 to drive its illumination. In addition, a light-shielding layer 69 is generally placed to cover and prevent light leakage through the tolerance gaps left after the assembly of the flexible printed circuit 68 and fluorescent lamp 66. Reference numeral 60 refers to the conventional backlight assembly including the frame 63, light-guide plate 61, reflective sheet 65, fluorescent lamp 66, reflector 67, flexible printed circuit 68, and light-shielding layer 68.

The construction of the conventional backlight 60 may not be economically satisfactory due to an excessive number of assembly components. Therefore, there is presently a need for a new backlight design that is simpler to assemble and has a lower manufacturing cost.

### SUMMARY OF THE INVENTION

The present application describes a backlight assembly for a liquid crystal display. According to one embodiment, the backlight assembly includes a frame configured to mount a liquid crystal panel, a light-guide plate and one or more light-emitting devices. The frame includes a plurality of conductive members embedded in the body of the frame and protruding into contact pads for connecting to the light-emitting device. The conductive members externally connect to a power source to supply electrical current to the light-emitting device.

In one embodiment, the light-emitting device is a light-emitting diode mounted facing a side of the light-guide plate opposite to the side of the liquid crystal display. The light-emitting device is positioned proximate to a side edge of the light-guide plate, and a reflection part is provided at the side edge so as to direct light towards a central area of the light-guide plate. In another embodiment, the light-emitting device is a light-emitting diode mounted in a manner to irradiate light incidental to a side edge of the light-guide plate.

In other variant embodiments, the contact pads are bent into resilient pads to which the light-emitting device connects by contact engagement.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is an exploded view illustrating the assembly of a backlight in a LCD system;

FIG. 1B is a cross-sectional view taken along the section 1B-1B in FIG. 1A;

FIG. 2A is an exploded view illustrating the assembly of a backlight in a LCD system according to an embodiment of the invention;

FIG. 2B is a cross-sectional view taken along the section 2B-2B in FIG. 2A;

FIG. 2C is a schematic view of a light-emitting device implemented in a backlight assembly according to an embodiment of the invention;

FIG. 2D is a cross-sectional view of a backlight assembly according to another embodiment, wherein the light-emitting device is connected by engagement with resilient contact pads;

FIGS. 2E˜2G are schematic views of a light-guide plate according to various embodiments of the invention;

FIG. 3A is a cross-sectional view of a backlight assembly according to another embodiment of the invention; and

FIG. 3B is a schematic view of a light-emitting device implemented in the backlight assembly according to another embodiment of the invention.

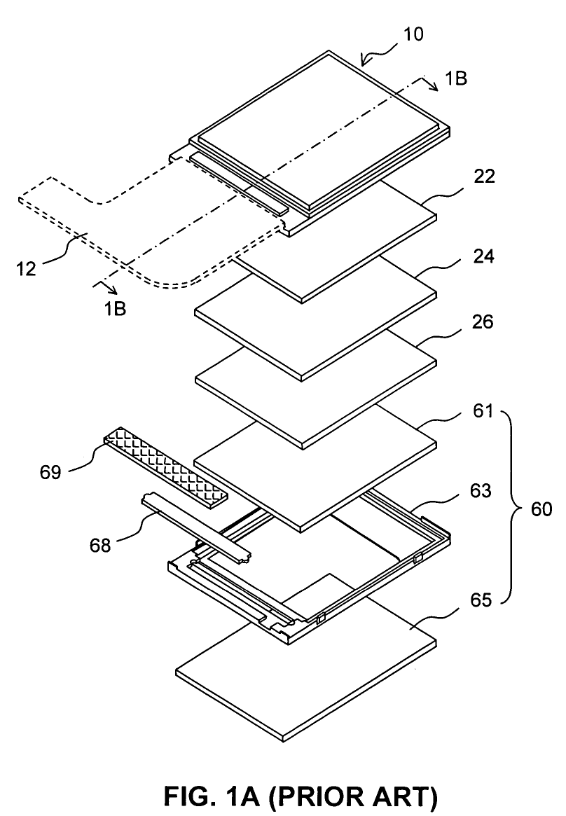

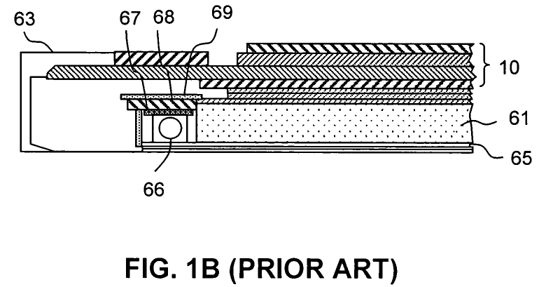

### DETAILED DESCRIPTION OF THE EMBODIMENT(S)

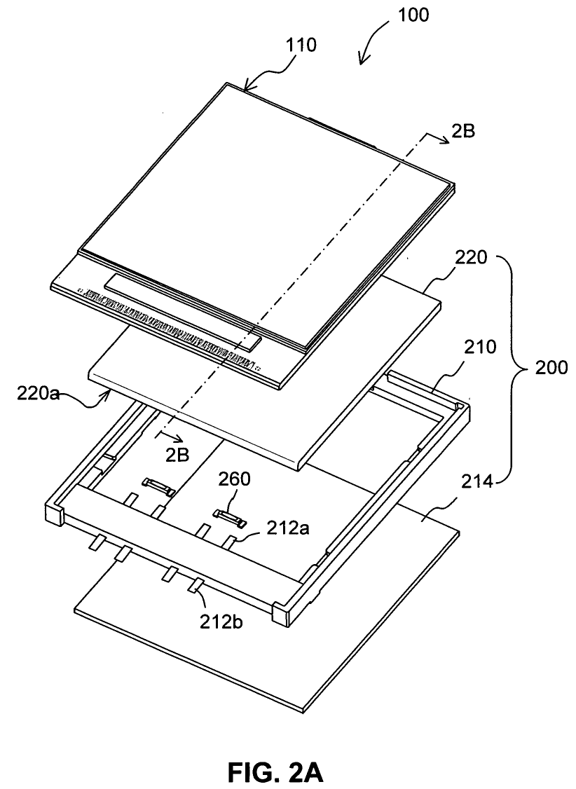

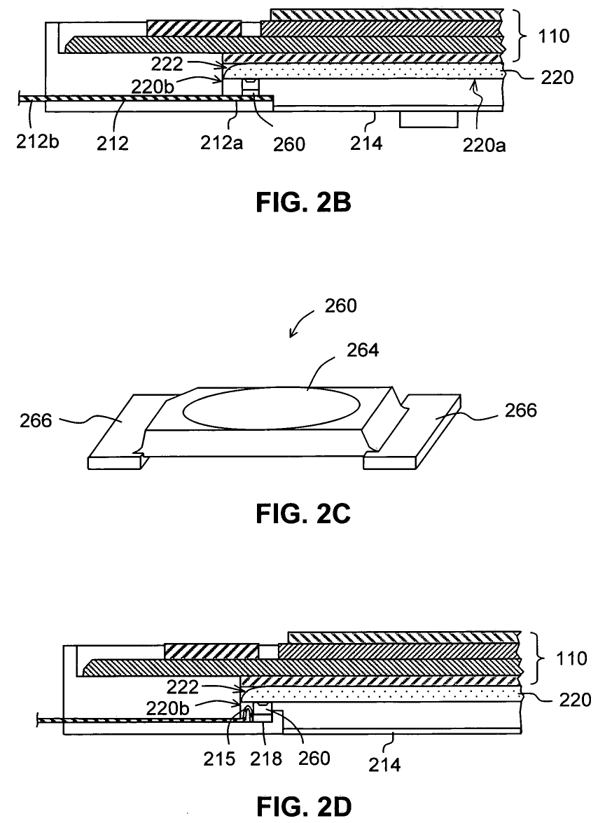

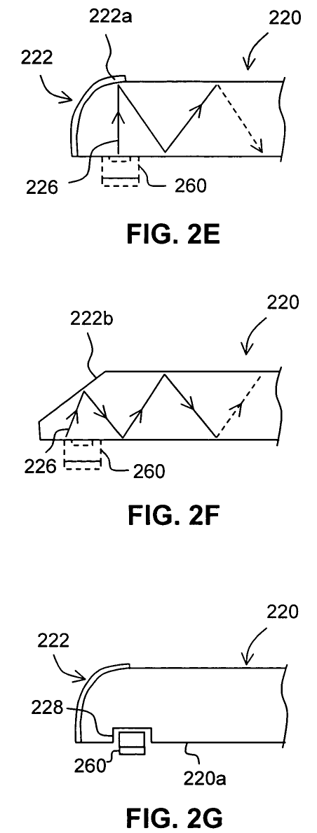

The application describes a backlight assembly for a liquid crystal display system. FIG. 2A is an exploded view showing the assembly of a liquid crystal display system 100 according to an embodiment of the invention, and FIG. 2B is a cross-sectional view taken along the section 2B-2B, showing the assembled liquid crystal display system. The liquid crystal display system 100 comprises a liquid crystal panel 110 mounted to a backlight system 200 via an assembly frame 210.

The liquid crystal panel 110 can be made of a multi-layer structure, including a liquid crystal layer sandwiched between two transparent substrates. The liquid crystal panel includes a plurality of pixel electrodes that are driven by means of switching devices to modulate light passage through the liquid crystal.

In the embodiment of FIG. 2A, one or more light-emitting devices 260 are mounted to the frame 210 by being connected to protruding contact pads 212a. A light-guide plate 220 is mounted to the frame 210 at a position between the light-emitting devices 260 and the liquid crystal panel 110. A reflective sheet 214 is assembled below the light-guide plate 220 so as to direct light towards the liquid crystal panel 110.

As shown in FIG. 2B, the contact pads 212a are extension portions of conductive members 212 embedded in the body of the frame 210. The conductive members 212 extend into terminals 212b outside the frame 210 which electrically connect to a power source (not shown). Various processing methods can be implemented to construct the frame 210 provided with embedded contact pads. In an example of manufacture by injection-molding, a plastic material can be injected in a mold where the conductive members are placed with the contact pads outwardly exposed. The contact pads 212a can be made of any conductive materials such as conductive metals or metallic alloys.

FIG. 2C illustrates an example of light-emitting device 260 implemented in the backlight of this embodiment. The light-emitting device 260 implemented in the invention can be a light-emitting diode. The light-emitting diode 260 includes a top light-irradiating surface 264 from which light irradiates outwardly, and terminal pads 266 for electrical connection. In the embodiment of FIGS. 2A-2B, the light-emitting diode can be mounted to the frame 210 with the terminal pads 266 connected to the contact pads 212 and the light-irradiating surface 264 facing the bottom surface 220a of the light-guide plate 220. Notwithstanding, other assembly configurations of the light-emitting device relative to the light-guide plate can be envisioned, as described later.

Methods such as soldering, press-bonding or the like can be implemented to connect the terminal pads 266 of the light-emitting device 260 to the contact pads 212. FIG. 2D shows another variant embodiment in which the frame 210 forms an accommodating space 218 and the contact pads are bent to form resilient pads 214. The light-emitting device 260 thereby can be mounted and connected by simple contact engagement with the resilient pads 214 in the accommodating space 218.

In the embodiments illustrated in FIGS. 2A-2B and 2D, the light-emitting device 260 is placed against the bottom surface 220a and proximate to a side edge 220b of the light-guide plate 220. To prevent light leakage at the periphery of the light-guide plate 220, the side edge 220b can include an edge reflection part 222 configured to reflect light 226 from the light-emitting device 260.

Many methods can be implemented to achieve the reflection part 222. FIG. 2E illustrates an example where the reflection part 222 is achieved by a reflective coating 222a covering the side edge surface of the light-guide plate 220. FIG. 2F illustrates another example where the reflection part 222 can be achieved by forming a side edge surface 222b inclined at an angle to reflect light 226 from the light-emitting device 260.

In the variant embodiment of FIG. 2G, the bottom surface 220a of the light-guide plate 220 further can be provided with recessed cavities 228. The cavities 228 receive the placement of the light-irradiating surface of the light-emitting device 260 so that the light path to the reflection part 222 is shortened.

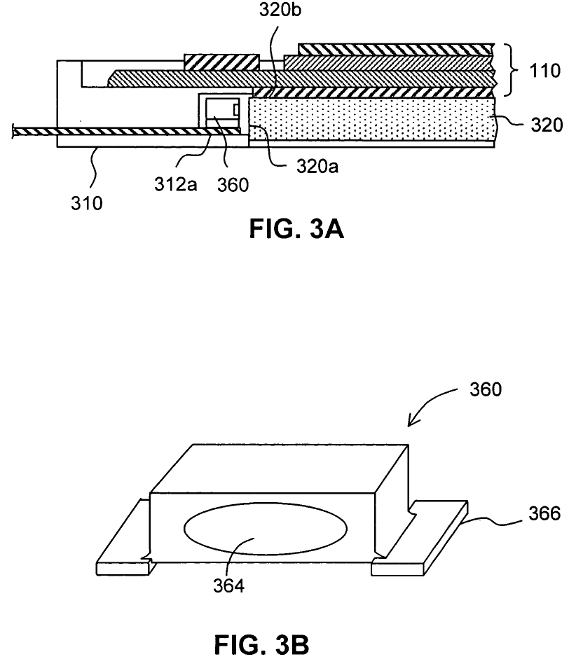

Reference now is made to FIGS. 3A-3B to describe a variant embodiment of a backlight assembly according to the invention. In this variant embodiment, the backlight frame 310 is configured to accommodate one or more light-emitting device 360 mounted to face a side edge 320a of the light-guide plate 320. The light-emitting device 360 connects to embedded contact pads 312a. Light irradiated from the light-emitting device 360 is incidental to a surface of the side edge 320a and emerges through top surface 320b of the light-guide plate 320 towards the liquid crystal panel 110.

FIG. 3B illustrates an example of light-emitting device 360 implemented in this embodiment. The light-emitting device 360 can be a light-emitting diode having a side light-irradiating surface 364 and terminal pads 366 for electrical connection. The light-emitting diode 360 is mounted to the frame 310 with the terminal pads 366 connected to the contact pads 312a and the side light-irradiating surface 364 facing the side edge surface 320a of the light-guide plate 320.

The backlight assembly as described herein has a simple construction and, in particular, does not necessitate a flexible printed circuit board which is a relatively expensive component. The mount of the light-emitting device to the frame of the backlight assembly at the same time achieves the electrical connection of the light-emitting device, which simplifies the assembly process and reduces the manufacturing cost.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. A backlight assembly for illuminating a liquid crystal panel, comprising:
a frame having a frame body in which are embedded a plurality of contact pads, wherein the frame body is configured to assemble the liquid crystal panel with the backlight assembly;
a light-guide plate mounted to the frame; and
one or more light-emitting device connected to the contact pads and respectively having a light-irradiating surface facing a first surface of the light-guide plate, light irradiated from the one or more light-emitting devices emerging out through a second surface of the light-guide plate towards the liquid crystal panel.

2. The backlight assembly according to claim 1, comprising a reflective sheet placed at a side of the light-guide plate to direct light towards the liquid crystal panel.

3. The backlight assembly according to claim 1, wherein the one or more light-emitting device is placed at a side of the light-guide plate opposite to the side of the liquid crystal panel.

4. The backlight assembly according to claim 3, wherein the one or more light-emitting device is positioned proximate to a side edge of the light-guide plate.

5. The backlight assembly according to claim 4, wherein a reflection member is provided in an area of the side edge of the light-guide plate to reflect light irradiated from the one or more light-emitting device.

6. The backlight assembly according to claim 5, wherein the reflection member is a reflective coating.

7. The backlight assembly according to claim 5, wherein the reflection member is a surface of the light-guide plate inclined at an angle.

8. The backlight assembly according to claim 3, wherein the light-guide plate includes one or more recessed cavity on the first surface for accommodating the light-irradiating surface of the one or more light-emitting device.

9. The backlight assembly according to claim 1, wherein the first surface of the light-guide plate is a side edge surface of the light-guide plate.

10. The backlight assembly according to claim 1, wherein the frame body is formed by injection-molding.

11. The backlight assembly according to claim 1, wherein the contact pads include resilient bent portions to which the one or more light-emitting device is connected by contact engagement.

12. The backlight assembly according to claim 1, wherein the one or more light-emitting device is connected to the contact pads by soldering.

13. The backlight assembly according to claim 1, wherein the contact pads are made of a conductive metal or metallic alloy.

14. The backlight assembly according to claim 1, wherein the one or more light-emitting device includes a light-emitting diode.

15. A frame structure for a backlight assembly, comprising:
a frame body configured to assemble a liquid crystal panel with the backlight assembly; and
a plurality of contact pads embedded in the frame body, wherein the contact pads externally connect to a power source and are configured to receive the mount of one or more light-emitting device.

16. The frame structure according to claim 15, wherein the frame body is formed by injection-molding.

17. The frame structure according to claim 15, wherein the contact pads include resilient bent portions to which the one or more light-emitting device is connected by engagement.

18. The frame structure according to claim 15, wherein the contact pads are made of a conductive metal or metallic alloy.

19. The frame structure according to claim 15, wherein the one or more light-emitting device includes a light-emitting diode.
